(19) United States
(12) Patent Application Publication
(10) Pub. No.: US 2019/0206338 A1
(43) Pub. Date: Jul. 4, 2019

(54) VOLTAGE CONTROL CIRCUIT, DISPLAY DEVICE AND VOLTAGE CONTROL METHOD

(71) Applicant: Shenzhen China Star Optoelectronics Technology Co. Ltd., Shenzhen (CN)

(72) Inventors: Wenfang LI, Shenzhen (CN); Xianming ZHANG, Shenzhen (CN)

(21) Appl. No.: 15/939,816

(22) Filed: Mar. 29, 2018

Related U.S. Application Data
(63) Continuation of application No. PCT/CN2018/072859, filed on Jan. 16, 2018.

(30) Foreign Application Priority Data
Dec. 29, 2017 (CN) 201711498486.6

(51) Int. Cl. G09G 3/36; G05F 1/10

(52) U.S. Cl. CPC G09G 3/36; G05F 1/10

(57) ABSTRACT

Embodiments of the disclosure provides a voltage control circuit, display device and voltage control method. The voltage control circuit adds an operation amplifying module, a current detecting module, a comparing module and an increasing module in a power management integrated circuit to connect the increasing module to the operation amplifying module to increase an amplifying magnification of the operation amplifying module when a voltage output from the output terminal is not enough due to increased voltage drop on the conducting wires caused by increased current output from the circuit, so that the output voltage output from the output terminal is increased.

### RELATED APPLICATIONS

This application is a continuation application of PCT Patent Application No. PCT/CN2018/072859, filed Jan. 16, 2018, which claims the priority benefit of Chinese Patent Application No. 201711498486.6, filed Dec. 29, 2017, which is herein incorporated by reference in its entirety.

### FIELD OF THE DISCLOSURE

The disclosure relates to an electronic circuit technical field, and more particularly to a voltage control circuit, display device and voltage control method.

### BACKGROUND

With the rapid development and popularization of liquid crystal displays (LCD), the competition in the LCD panel market is getting fiercer. In order to control the cost, the combination of the driver board and the control board is inevitably more and more. Due to the reduced area of the combined printed circuit board, the necessary wires for connecting the output terminal of the power management integrated circuit (PMIC) to the printed circuit board must be increased, and the increase of the wire leads to the increase of the wire resistance, which in turn causes the voltage distributed on the wire to increase. After reaching the printed circuit board, the core voltage output from the PMIC is not enough for normally operating the printed circuit board.

### SUMMARY

Embodiments of the present disclosure provides a voltage control circuit to increase the output voltage at the output terminal when the output voltage at the output terminal is not enough.

In a first aspect, the embodiment of the present disclosure provides a voltage control circuit applied to a power management integrated circuit, comprising an operation amplifying module, a current detecting module, a comparing module and an increasing module, wherein,

the operation amplifying module is configured for amplifying an input voltage on a first input terminal of the operation amplifying module and outputting the amplified input voltage to an output terminal of the power management integrated circuit, wherein the operation amplifying module generates an output current in accordance with the input voltage;

the current detecting module is configured for detecting an output current value of the power management integrated circuit and feeding back the output current value to the comparing module;

the comparing module is configured for comparing the output current value with a predetermined current value and outputting a comparing result of the comparison; and

the increasing module is configured for connecting to a second input terminal of the operation amplifying module to increase an amplifying magnification of the operation amplifying module when the comparing result represents that the output current value is greater than the predetermined current value, so as to increase an output voltage value of the power managing integrated circuit.

In one embodiment, the operation amplifying module comprises an operation amplifier, a first resistor and a second resistor, wherein a first input terminal of the operation amplifier receives an input voltage, a second terminal of the operation amplifier is connected to a first terminal of the first resistor, a second terminal of the first resistor is connected to ground, a first terminal of the second resistor is connected to a second input terminal of the operation amplifier, and a second terminal of the second resistor is connected to the output terminal of the power management integrated circuit; wherein, the operation amplifier amplifies a voltage input to the first input terminal of the operation amplifier and outputs the amplified voltage to the output terminal of the power management integrated circuit.

In one embodiment, the comparing module comprises a comparator, a positive input terminal of the comparator receives the output current value detected by the current detecting module, a negative input terminal of the comparator receives the predetermined current value, and an output terminal of the comparator is connected to the increasing module.

In one embodiment, the increasing module comprises a transistor and an increasing module resistor, a gate electrode of the transistor is connected to the output terminal of the comparator, a source electrode of the transistor is connected to ground, a drain electrode of the transistor is connected to a first terminal of the increasing module resistor, and a second terminal of the increasing module resistor is connected to the second input terminal of the operation amplifying module; wherein, when the comparing result of the comparing module represents that the output current value is greater than the predetermined current value of the comparing module, the transistor is conducted, and the increasing module resistor is connected to ground through the transistor so that the increasing module is connected to the second input terminal of the operation amplifying module to increase the output voltage value.

In one embodiment, the voltage control circuit comprises m comparing modules and m increasing modules, the m comparing modules are corresponding to the m increasing modules one by one, and m is an integer; wherein, when a comparing result of a nth comparing module in the m comparing modules represents that the output current value is greater than a nth predetermined current value of the nth comparing module, the nth comparing module in the m comparing modules is connected to the second input terminal of the operation amplifying module due to the comparing result to increase the amplifying magnification of the operation amplifying module to increase the output voltage value, and n is an integer, nm.

In one embodiment, m equals to 2, and the voltage control circuit comprises a first comparing module, a first increasing module, a second comparing module and a second increasing module; wherein, when the comparing result of a first comparator of the first comparing module represents that the output current value is greater than a first predetermined current value, a first transistor of the first increasing module is conducted so that the first increasing module is connected to the second input terminal of the operation amplifying module; when the comparing result of a second comparator of the second comparing module represents that the output current value is greater than a second predetermined current value, a second transistor of the second increasing module is conducted so that the second increasing module is connected to the second input terminal of the operation amplifying module.

In one embodiment, the first comparing module comprises the first transistor, the first increasing module comprises the first transistor and a third resistor, the second comparing module comprises the second comparator, and the second increasing module comprises the second transistor and a fourth resistor; the increasing module resistor comprises the third resistor and the fourth resistor; wherein, a positive input terminal of the first comparator receives the output current value detected by the current detecting module, a negative input terminal of the first comparator receives the first predetermined current value, and an output terminal of the first comparator is connected to a gate electrode of the first transistor; a positive input terminal of the second comparator receives the output current value detected by the current detecting module, a negative input terminal of the second comparator receives the second predetermined current value, and an output terminal of the second comparator is connected to a gate electrode of the second transistor; a source electrode of the first transistor is connected to ground, a drain electrode of the first transistor is connected to a first terminal of the third resistor, and a second terminal of the third resistor is connected to the second input terminal of the operation amplifier; a source electrode of the second transistor is connected to ground, a drain electrode of the second transistor is connected to a first terminal of the fourth resistor, and a second terminal of the fourth resistor is connected to the second input terminal of the operation amplifier.

In a second aspect, the embodiment of the present disclosure provides a display device, which comprises the voltage control circuit described in the first aspect above.

In a third aspect, the embodiment of the present disclosure provides a voltage control method applied to the voltage control circuit described in the first aspect above. The voltage control method comprises:

detecting an output current value output from the voltage control circuit;

comparing the output current value with a predetermined current value; and

increasing an output voltage amplifying magnification of the voltage control circuit to increase an output voltage output from the voltage control circuit when the output current value is greater than the predetermined current value.

In one embodiment, N predetermined current values are set, wherein N is an integer; and, when the output current value is greater than an ith predetermined current value of the N predetermined current values, the output voltage amplifying magnification is increased to an amplifying magnification corresponding to the ith predetermined current value.

The embodiments of the present disclosure add voltage control circuit in the power management integrated circuit to adjust the amplifying magnification of the operation amplifying module of the voltage control circuit when the voltage output from the output terminal is decreased due to increased voltage drop on the conducting wires caused by increased current output from the circuit, so that the output voltage output from the power management integrated circuit is increased.

### BRIEF DESCRIPTION OF THE DRAWINGS

In order to make the descriptions of the technique solutions of the embodiments of the present disclosure or the existed techniques, the drawings necessary for describing the embodiments or the existed techniques are briefly introduced below. Obviously, the drawings described below are only some embodiments of the present disclosure, and, for those with ordinary skill in this field, other drawings can be obtained from the drawings described below without creative efforts.

FIG. 1 is a structural schematic diagram of the voltage control circuit provided in the first embodiment of the present disclosure.

FIG. 2 is a connection schematic diagram of the voltage control circuit provided in the second embodiment of the present disclosure.

FIG. 3 is a connection schematic diagram of the voltage control circuit provided in the third embodiment of the present disclosure.

FIG. 4 is a flow chart of the voltage control method provided in one embodiment of the present disclosure.

### DETAILED DESCRIPTION OF PREFERRED EMBODIMENTS

The technical solutions in the embodiments of the present disclosure will be described clearly and completely hereinafter with reference to the accompanying drawings in the embodiments of the present disclosure. Apparently, the described embodiments are merely some but not all embodiments of the present disclosure. All other embodiments obtained by persons with ordinary skill in the art based on the embodiments of the present invention without creative efforts shall fall within the protection scope of the present invention.

It is noted that, the terms used herein are only for illustrating concrete embodiments rather than limiting the exemplary embodiments. Unless otherwise indicated in the content, singular forms “a” and “an” also include plural. Moreover, the term “and/or” means and includes any or all possible combinations of one or more of the associated listed items.

The terms “comprising” and “including”, as well as any variations thereof in the description and claims of the present disclosure and the above drawings, are intended to cover the inclusion of non-exclusive inclusions. For example, comprising a process, method, system, product, or device that incorporates a series of steps or units is not limited to the steps or units listed but may optionally further include steps or units not listed or may optionally further include other steps or units inherent to these processes, methods, products, or devices.

It is noted that, the embodiments of the present disclosure are described in detail below. Examples of the embodiments are shown in the accompanying drawings, where the same or similar reference numbers indicate the same or similar elements or elements having the same or similar functions from beginning to end. The embodiments described below with reference to the accompanying drawings are exemplary only to explain the present invention and should not be construed as limiting the present invention.

In the description of the present disclosure, it should be noted that the terms “mounted”, “connect with”, “connect to” and “connect” should be broadly understood unless otherwise specified and limited. For example, they may be mechanical connections or electrical connections, or may be the intercommunication between the two components. The intercommunication may be direct connection or indirect connection through an intermediary medium. For those skilled in the art, the specific meanings of the above terms may be understood according to specific situations.

As used in this specification and the appended claims, the term “if” may be interpreted as “when” or “once” or “in response to a determination” or “in response to a detection” according to the context containing the term. Similarly, the phrase “if determined” or “if [described condition or event] is detected” may be interpreted from the context to mean “once determined” or “in response to a determination” or “once the [described condition or event] is detected” or “in response to detecting [described condition or event]”.

In the embodiments of the present disclosure, the voltage control circuit is applied to an integrated circuit. As the size of the integrated circuit becomes smaller and smaller currently, the size of some terminal devices using an integrated circuit is getting larger. For example, in a liquid crystal display, in order to control the cost, a driving architecture having a PCB merging both driving board and control board would be increased. Due to the decreasing size of combined PCB area and the increasing size of the liquid crystal display, length of conducting wires from the power management integrated circuit (PMIC) to the printed circuit board is increased and results in increasing resistance, which further results in sharing more voltage on the conducting wires. The core voltage output from PMIC is not enough for supporting normal operation of the panel when the core voltage reaches the printed circuit board. Once the output core voltage of the PMIC is directly raised, the voltage at the input end of the printed circuit board may exceed the voltage required for normal operation at the instant when the LCD is turned on, thereby damaging the panel. In order to solve the above problem, the present disclosure provides a voltage control circuit. By adding a voltage control circuit inside the PMIC, when the output voltage at the output terminal is insufficient because of the increasing voltage drop on the conducting wire due to the gradual increase of the current on the conducting wire, the amplifying magnification of the operation amplifier in the voltage control circuit can be adjusted to increase the output voltage of the PMIC.

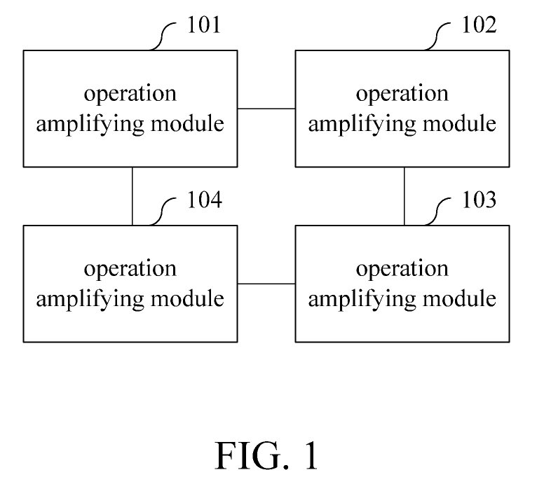

Please refer to FIG. 1, which is a structural schematic diagram of the voltage control circuit provided in the first embodiment of the present disclosure. As shown in FIG. 1, the voltage control circuit in the present embodiment is applied to the PMIC and the voltage control circuit comprises an operation amplifying module 101, a current detecting module 102, a comparing module 103 and an increasing module 104, wherein,

the operation amplifying module 101 is configured for amplifying an input voltage on a first input terminal of the operation amplifying module 101 and outputting the amplified input voltage to an output terminal of the PMIC, wherein the operation amplifying module 101 generates an output current in accordance with the input voltage;

the current detecting module 102 is configured for detecting an output current value of the output terminal of the PMIC and feeding back the output current value to the comparing module 103;

the comparing module 103 is configured for comparing the output current value with a predetermined current value and outputting a comparing result of the comparison; and

the increasing module 104 is configured for connecting to a second input terminal of the operation amplifying module 101 to increase an amplifying magnification of the operation amplifying module 101 when the comparing result represents that the output current value is greater than the predetermined current value, so as to increase an output voltage value of the PMIC.

Wherein, the first input terminal of the operation amplifying module 101 receives the input voltage, the output terminal of the operation amplifying module 101 is connected to the current detecting module 102, the current detecting module 102 is connected to the comparing module 103, and the output terminal of the comparing module 103 is connected to the increasing module 104.

In the embodiment, when the circuit is conducted, the operation amplifying module 101 amplifies the input voltage input from the first input terminal to obtain a first output voltage and outputs the first output voltage to the output terminal, and, at the same time, the output current is generated from the output terminal of the operation amplifying module 101. The current detecting module 102 detects the output current value of the output current output from the output terminal and feeds back the output current value to the comparing module 103. As the output current value increases, the voltage drop on the conducting wire between the output terminal of the operation amplifying module 101 and the load is increased so that the voltage on the input terminal of the load is decreased. When the output current value is greater than the predetermined current value of the comparing module 103, the comparing module 103 outputs the comparing result. When the comparing result represents that the output current value is greater than the predetermined current value of the comparing module 103, the increasing module 104 is connected to the second input terminal of the operation amplifying module 101 to increase the amplifying magnification of the operation amplifying module 101 to increase the output voltage value.

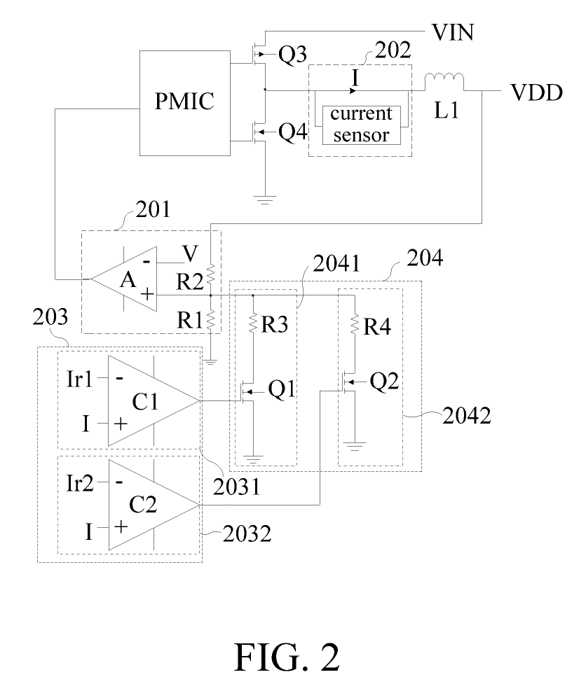

Please refer to FIG. 2, which is a connection schematic diagram of the voltage control circuit provided in the second embodiment of the present disclosure. As shown in FIG. 2, the voltage control circuit in the present embodiment is applied to PMIC, and the voltage control circuit comprises an operation amplifying module 201, a current detecting module 202, a comparing module 203 and an increasing module 204, wherein,

the operation amplifying module 201 is configured for amplifying an input voltage on a first input terminal of the operation amplifying module 201 and outputting the amplified input voltage to an output terminal of the PMIC, wherein the operation amplifying module 201 generates an output current in accordance with the input voltage;

the current detecting module 202 is configured for detecting an output current value of the output terminal of the PMIC and feeding back the output current value to the comparing module 203;

the comparing module 203 is configured for comparing the output current value with a predetermined current value and outputting a comparing result of the comparison; and

the increasing module 204 is configured for connecting to a second input terminal of the operation amplifying module 201 when the comparing result represents that the output current value is greater than the predetermined current value, so as to increase an amplifying magnification of the operation amplifying module 201 to increase an output voltage value of the PMIC.

Wherein, the first input terminal of the operation amplifying module 201 receives the input voltage, the output terminal of the operation amplifying module 201 is connected to the input terminal of the PMIC, the current detecting module 202 is connected to the comparing module 203, and the output terminal of the comparing module 203 is connected to the increasing module 204.

Wherein, the operation amplifying module 201 comprises the operation amplifier A, the first resistor R1 and the second resistor R2. The first input terminal of the operation amplifier A receives the input voltage, the second input terminal of the operation amplifier A is connected to the first terminal of the first resistor R1, the second terminal of the first resistor R1 is connected to ground, the first terminal of the second resistor R2 is connected to the second input terminal of the operation amplifier A, and the second terminal of the second resistor R2 is connected to the output terminal of the PMIC.

The current detecting module 202 comprises a current sensor connected to the output terminal of the PMIC.

The comparing module 203 comprises a first comparing module 2031 and a second comparing module 2032. The first comparing module 2031 comprises a first comparator C1, the positive input terminal of the first comparator C1 receives the output current value I detected by the current sensor, the negative input terminal of the first comparator C1 receives a first predetermined current value Iᵣ₁, and the output terminal of the first comparator C1 is connected to the increasing module 204. The second comparing module 2032 comprises a second comparator C2, the positive input terminal of the second comparator C2 receives the output current value I detected by the current sensor, the negative input terminal of the second comparator C2 receives a second predetermined current value Iᵣ₂, and the output terminal of the second comparator C2 is connected to the increasing module 204. Wherein, the first predetermined current value Iᵣ₁ is smaller than the second predetermined current value Iᵣ₂.

The increasing module 204 comprises a first increasing module 2041 and a second increasing module 2042. The first increasing module 2041 comprises the first transistor Q1 and the third resistor R3, the gate electrode of the first transistor Q1 is connected to the output terminal of the first comparator C1, the source electrode of the first transistor Q1 is connected to ground, the drain electrode of the first transistor Q1 is connected to the first terminal of the third resistor R3, and the second terminal of the third resistor R3 is connected to the second input terminal of the operation amplifier A. The second increasing module 2042 comprises the second transistor Q2 and the fourth resistor R4, the gate electrode of the second transistor Q2 is connected to the output terminal of the second comparator C2, the source electrode of the second transistor Q2 is connected to ground, the drain electrode of the second transistor Q2 is connected to the first terminal of the fourth resistor R4, and the second terminal of the fourth resistor R4 is connected to the second input terminal of the operation amplifier A.

In the time t0 when the circuit starts to operate, the output current detected by the current sensor is less than the first predetermined current value Iᵣ₁ and the second predetermined current value Iᵣ₂, the outputs of the first comparator C1 and second comparator C2 are at low level, the first transistor Q1 and second transistor Q2 are both turned off, and the second input terminal of the operation amplifier A is only connected to the first resistor R1 and the second resistor R2. According to the operation principle of an operation amplifier, the output voltage of the operation amplifier is:

$${V}_{DD 0} = V \times ( 1 + \frac{{R}_{2}}{{R}_{1}} )$$

Wherein, V_{DD0} is the output voltage of the operation amplifier A at the time t0, V is the input voltage of the first input terminal of the operation amplifier A, R₁ is the resistance of the first resistor R1, and R₂ is the resistance of the second resistor R2.

As the current in the circuit increases, at the time t1 when the first current value I1 detected by the current sensor is greater than the first predetermined current value Iᵣ₁, the first comparator C1 outputs a high level, the first transistor Q1 is turned on by the high level output from the first comparator C1 to connect the third resistor R3 to ground through the first transistor Q1, so that the first increasing unit 2041 is connected to the second input terminal of the operation amplifying module 201. According to the operation principle of an operation amplifier, the output voltage of the operation amplifier is:

$${V}_{DD 1} = V \times ( 1 + \frac{{R}_{2}}{{R}_{1} \times {R}_{3} / ( {R}_{1} + {R}_{3} )} )$$

Wherein, V_{DD1} is the output voltage of the operation amplifier A at the time t1, V is the input voltage of the first input terminal of the operation amplifier A, R₁ is the resistance of the first resistor R1, R₂ is the resistance of the second resistor R2, and R₃ is the resistance of the third resistor R3. Because R₁×R₃/(R₁+R₃)<R₁, V_{DD1}>V_{DD0} i.e., the output voltage of the PMIC is increased accordingly, wherein t1>t0.

As the current in the circuit further increases, at the time t2 when the second current value I2 detected by the current sensor is greater than the second predetermined current Iᵣ₂, the second comparator C2 outputs a high level, the second transistor Q2 is turned on by the high level output from the second comparator C2 to connect the fourth resistor R4 to ground through the second transistor Q2, so that the second increasing unit 2042 is also connected to the second input terminal of the operation amplifying module 201. According to the operation principle of an operation amplifier, the output voltage of the operation amplifier is:

$${V}_{DD 2} = V \times ( 1 + \frac{{R}_{2}}{{R}_{1} \times {R}_{3} \times {R}_{4} / ( {R}_{1} + {R}_{3} + {R}_{4} )} )$$

Wherein, V_{DD2} is the output voltage of the operation amplifier A at the time t2, V is the input voltage of the first input terminal of the operation amplifier A, R₁ is the resistance of the first resistor R1, R₂ is the resistance of the second resistor R2, R₃ is the resistance of the third resistor R3, and R₄ is the resistance of the fourth resistor R4. Because R₁×R₃×R₄/(R₁+R₃+R₄)<R₁×R₃/(R₁×R₃), V_{DD2}>V_{DD1} i.e., the output voltage of the PMIC is further increased.

Selectively, the transistor could be semi-controlled transistor, or the transistor could be full-controlled transistor, for example, thyristor, silicon controlled rectifier, or fast thyristor. Or the transistor could be full-controlled power switching device, such as insulated gate bipolar transistor (IGBT), metal-oxide-semiconductor field-effect transistor (MOSFET), power field-effect transistor, gate turn-off thyristor (GTO), etc., and is not restricted in the embodiment.

It can be found that, the embodiments of the present disclosure add voltage control circuit in the PMIC to adjust the amplifying magnification of the operation amplifying module of the voltage control circuit when the voltage output from the output terminal is decreased due to increased voltage drop on the conducting wires caused by increased current output from the circuit, so that the output voltage output from the PMIC is increased.

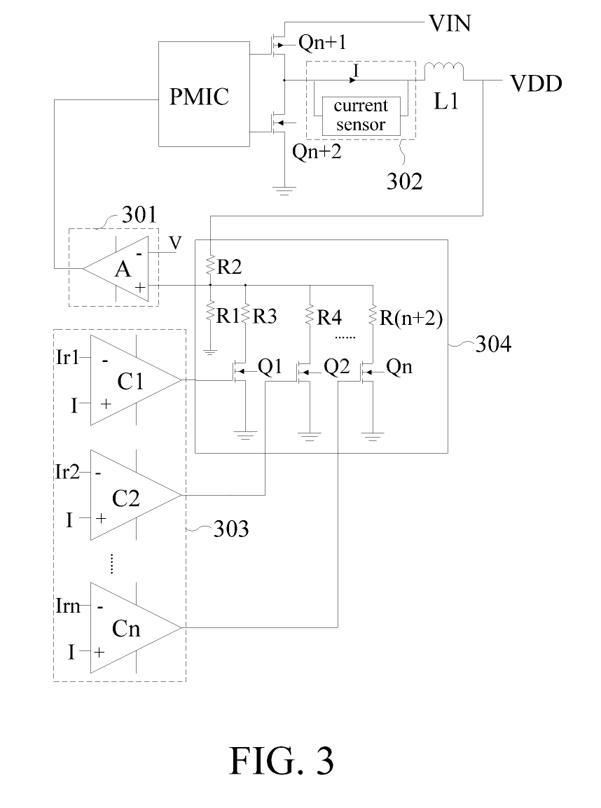

Please refer to FIG. 3, which is a connection schematic diagram of the voltage control circuit provided in the third embodiment of the present disclosure. As shown in FIG. 3, the voltage control circuit of the present embodiment is applied to PMIC and comprises an operation amplifying module 301, a current detecting module 302, a comparing module 303 and an increasing module 304, wherein,

the operation amplifying module 301 is configured for amplifying an input voltage on a first input terminal of the operation amplifying module 301 and outputting the amplified input voltage to an output terminal of the PMIC, wherein the operation amplifying module 301 generates an output current in accordance with the input voltage;

the current detecting module 302 is configured for detecting an output current value of the output terminal of the PMIC and feeding back the output current value to the comparing module 303;

the comparing module 303 is configured for comparing the output current value with a predetermined current value and outputting a comparing result of the comparison; and

the increasing module 304 is configured for connecting to a second input terminal of the operation amplifying module 301 when the comparing result represents that the output current value is greater than the predetermined current value, so as to increase an amplifying magnification of the operation amplifying module 301 to increase an output voltage value of the PMIC.

Wherein, the first input terminal of the operation amplifying module 301 receives the input voltage, the output terminal of the operation amplifying module 301 is connected to the input terminal of the PMIC, the current detecting module 302 is connected to the comparing module 303, and the output terminal of the comparing module 303 is connected to the increasing module 304.

Wherein, the operation amplifying module 301 comprises the operation amplifier A, the first resistor R1 and the second resistor R2. The first input terminal of the operation amplifier A receives the input voltage, the second input terminal of the operation amplifier A is connected to the first terminal of the first resistor R1, the second terminal of the first resistor R1 is connected to ground, the first terminal of the second resistor R2 is connected to the second input terminal of the operation amplifier A, and the second terminal of the second resistor R2 is connected to the output terminal of the PMIC.

The current detecting module 302 comprises a current sensor connected to the output terminal of the PMIC.

In the present embodiment, the voltage control circuit comprises m comparing modules and m increasing modules, and the m comparing modules are corresponding to the m increasing modules one by one. A nth comparing module of the m comparing modules comprises a nth comparator Cn, a positive input terminal of the nth comparator Cn receives the output current value I detected by the current detecting module, a negative input terminal of the nth comparator Cn receives a nth predetermined current value Iᵣₙ, and an output terminal of the nth comparator Cn is connected to the corresponded nth increasing module. The nth increasing module comprises a nth transistor Qn and a (n+2)th resistor R(n+2), a gate electrode of the nth transistor Qn is connected to the output terminal of the nth comparator Cn of the corresponded nth comparing module, a source electrode of the nth transistor Qn is connected to ground, a drain electrode of the nth transistor Qn is connected to a first terminal of the (n+2)th resistor R(n+2), and a second terminal of the (n+2)th resistor R(n+2) is connected to the second input terminal of the operation amplifying module. Wherein, m, n are integers and n≤m.

Wherein, when the comparing result of the nth comparator represents that the output current value is greater than the nth predetermined current value of the nth comparing module, the nth transistor is conducted to connect the (n+2)th resistor to ground through the nth transistor, so that the nth increasing module is connected to the operation amplifying module to increase the amplifying magnification of the operation amplifying module to further increase the output voltage value.

For example, in the time t0 when the circuit starts to operate, the output current I detected by the current sensor is less than the first predetermined current value Iᵣ₁, the output of the first comparator C1 is at low level, the first transistor Q1 is turned off, and the second input terminal of the operation amplifier A is only connected to the first resistor R1 and the second resistor R2. According to the operation principle of an operation amplifier, the output voltage of the operation amplifier is:

$${V}_{DD 0} = V \times ( 1 + \frac{{R}_{2}}{{R}_{1}} )$$

Wherein, V_{DD0} is the output voltage of the operation amplifier A at the time t0, V is the input voltage of the first input terminal of the operation amplifier A, R₁ is the resistance of the first resistor R1, and R2 is the resistance of the second resistor R2.

As the current in the circuit increases, at the time t1 when the first current value I1 detected by the current sensor is greater than the first predetermined current value Iᵣ₁, the first comparator C1 outputs a high level, the first transistor Q1 is turned on by the high level output from the first comparator C1 to connect the third resistor R3 to ground through the first transistor Q1, so that the first increasing unit 2041 is connected to the second input terminal of the operation amplifying module. According to the operation principle of an operation amplifier, the output voltage of the operation amplifier is:

$${V}_{DD 1} = V \times ( 1 + \frac{{R}_{2}}{{R}_{1} \times {R}_{3} / ( {R}_{1} + {R}_{3} )} )$$

Wherein, V_{DD1} is the output voltage of the operation amplifier A at the time t1, V is the input voltage of the first input terminal of the operation amplifier A, R₁ is the resistance of the first resistor R1, R₂ is the resistance of the second resistor R2, and R₃ is the resistance of the third resistor R3. Because R₁×R₃/(R₁+R₃)<R₁, V_{DD1}>V_{DD0} i.e., the output voltage of the PMIC is increased accordingly.

As the current in the circuit further increases, at the time tn when the output current value In detected by the current sensor is greater than the nth predetermined current value Iᵣₙ of the nth comparator in the m comparing modules, the nth comparator of the nth comparing module outputs a high level to turn on the nth transistor Qn of the nth increasing module, so that the (n+2)th resistor R(n+2) is connected to ground through the nth transistor Qn, and the nth increasing unit is connected to the second input terminal of the operation amplifier A. According to the operation principle of an operation amplifier, the output voltage of the operation amplifier is:

$${V}_{DDn} = V \times ( 1 + \frac{{R}_{2}}{{R}_{1} \times {R}_{3} \times L \times {R}_{n + 2} / ( {R}_{1} + {R}_{3} + L + {R}_{n + 2} )} )$$

Wherein, V_{DDn} is the output voltage of the operation amplifier A at the time tn, V is the input voltage of the first input terminal of the operation amplifier A, R₁ is the resistance of the first resistor R1, R₂ is the resistance of the second resistor R2, R₃ is the resistance of the third resistor R3, and Rₙ₊₂ is the resistance of the (n+2)th resistor R(n+2).

Selectively, the transistor could be semi-controlled transistor or full-controlled transistor, for example, thyristor, silicon controlled rectifier, or fast thyristor. Or the transistor could be full-controlled power switching device, such as IGBT, MOSFET, power field-effect transistor, GTO, etc., and is not restricted in the embodiment.

It can be found that, the embodiments of the present disclosure add voltage control circuit in the PMIC to adjust the amplifying magnification of the operation amplifying module of the voltage control circuit when the voltage output from the output terminal is decreased due to increased voltage drop on the conducting wires caused by increased current output from the circuit, so that the output voltage output from the PMIC is increased.

The embodiments of the present disclosure further provide a display device, and the display device comprises the modules included in the voltage control circuit described in any one of the first embodiment, second embodiment and third embodiment. The procedure for realizing voltage control by the display device can be referred to the specific procedure described in any one of the embodiments described above and is not repeated here.

The embodiments of the present disclosure further provide an electronic apparatus comprising the modules included in the voltage control circuit described in any one of the first embodiment, second embodiment and third embodiment. The procedure for realizing voltage control by the electronic apparatus can be referred to the specific procedure described in any one of the embodiments described above and is not repeated here.

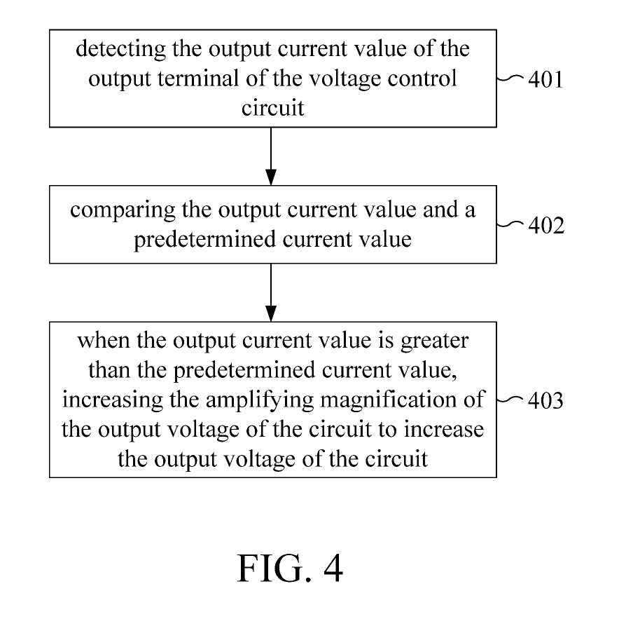

Please refer to FIG. 4, which is a flow chart of the voltage control method provided in one embodiment of the present disclosure. The voltage control method can be applied to the voltage control circuit described in any one of the embodiments described above. The voltage control method comprises:

401: detecting the output current value of the output terminal of the voltage control circuit;

402: comparing the output current value and a predetermined current value;

403: when the output current value is greater than the predetermined current value, increasing the amplifying magnification of the output voltage of the circuit to increase the output voltage of the circuit.

In the present embodiment, the current value of the output terminal of the circuit is detected when the circuit starts to work. When the output current value is greater than the predetermined current value, the voltage drop on the conducting wire is too large to reduce the output voltage of the output terminal of the circuit, and the voltage amplifying magnification of the circuit is increased at this time to increase the output voltage of the circuit.

Selectively, the circuit could set N predetermined current values. When the output current value is greater than the ith predetermined current value of the N predetermined current values, the output voltage amplifying magnification of the circuit is increased to the amplifying magnification corresponding to the ith predetermined current value.

For example, assuming that the first predetermined current value of the N predetermined current values is I1, the output voltage amplifying magnification corresponding to the first predetermined current value is a, the second predetermined current value of the N predetermined current values is I2, and the output voltage amplifying magnification corresponding to the second predetermined current value is b, wherein I1<I2, a<b, the output voltage amplifying magnification is adjusted to be a when the detected output current value is greater than I1, and, when the current in the circuit increases so that the output current value is greater than I2, the output voltage amplifying magnification is adjusted to be b. It should be understood that the embodiments above are only for examples but not for specific limitations.

Those with ordinary skill in the art may be aware that, the modules and method steps of the examples described in conjunction with the embodiments disclosed herein may be implemented by electronic hardware, computer software, or a combination of the two. To clearly describe that the hardware and software are interchangeable, the composition and the steps of the examples have been generally described in terms of their functions in above description. Whether these functions are implemented by hardware or software depends on the specific application and design constraints of the technical solutions. A person skilled in the art may use different methods to implement the described functions for each particular application, but such implementation should not be considered as beyond the scope of the present invention.

In the several embodiments provided in the present disclosure, it should be understood that the disclosed circuits and methods may be implemented in other manners. For example, the above-described embodiments are merely exemplary. For example, the module division is merely logical function division and may be other division in actual implementation. For example, a plurality of components may be combined or integrated into another system, or some of the features can be ignored or not executed. In addition, the mutual coupling or direct coupling or communication connection shown or discussed may be indirect coupling or communication connection through some interfaces, devices or units, and may also be electrical, mechanical or other forms of connection.

The foregoing contents are detailed description of the disclosure in conjunction with specific preferred embodiments and concrete embodiments of the disclosure are not limited to the description. For the person skilled in the art of the disclosure, without departing from the concept of the disclosure, simple deductions or substitutions can be made and should be included in the protection scope of the application.

What is claimed is:

1. A voltage control circuit applied to a power management integrated circuit, comprising an operation amplifying module, a current detecting module, a comparing module and an increasing module, wherein,
the operation amplifying module is configured for amplifying an input voltage on a first input terminal of the operation amplifying module and outputting the amplified input voltage to an output terminal of the power management integrated circuit, wherein the operation amplifying module generates an output current in accordance with the input voltage;
the current detecting module is configured for detecting an output current value of the power management integrated circuit and feeding back the output current value to the comparing module;
the comparing module is configured for comparing the output current value with a predetermined current value and outputting a comparing result of the comparison; and
the increasing module is configured for connecting to a second input terminal of the operation amplifying module to increase an amplifying magnification of the operation amplifying module when the comparing result represents that the output current value is greater than the predetermined current value, so as to increase an output voltage value of the power managing integrated circuit.

2. The voltage control circuit according to claim 1, wherein the operation amplifying module comprises an operation amplifier, a first resistor and a second resistor, wherein a first input terminal of the operation amplifier receives an input voltage, a second terminal of the operation amplifier is connected to a first terminal of the first resistor, a second terminal of the first resistor is connected to ground, a first terminal of the second resistor is connected to a second input terminal of the operation amplifier, and a second terminal of the second resistor is connected to the output terminal of the power management integrated circuit;
wherein, when the voltage control circuit works normally, the operation amplifier amplifies a voltage input to the first input terminal of the operation amplifier and outputs the amplified voltage to the output terminal of the power management integrated circuit.

3. The voltage control circuit according to claim 1, wherein the comparing module comprises a comparator, a positive input terminal of the comparator receives the output current value detected by the current detecting module, a negative input terminal of the comparator receives the predetermined current value, and an output terminal of the comparator is connected to the increasing module.

4. The voltage control circuit according to claim 3, wherein the increasing module comprises a transistor and an increasing module resistor, a gate electrode of the transistor is connected to the output terminal of the comparator, a source electrode of the transistor is connected to ground, a drain electrode of the transistor is connected to a first terminal of the increasing module resistor, and a second terminal of the increasing module resistor is connected to the second input terminal of the operation amplifying module;
wherein, when the comparing result of the comparing module represents that the output current value is greater than the predetermined current value of the comparing module, the transistor is conducted, and the increasing module resistor is connected to ground through the transistor so that the increasing module is connected to the second input terminal of the operation amplifying module to increase the output voltage value.

5. The voltage control circuit according to claim 1, wherein the voltage control circuit comprises m comparing modules and m increasing modules, the m comparing modules are corresponding to the m increasing modules one by one, and m is an integer;
wherein, when a comparing result of a nth comparing module in the m comparing modules represents that the output current value is greater than a nth predetermined current value of the nth comparing module, the nth comparing module in the m comparing modules is connected to the second input terminal of the operation amplifying module due to the comparing result to increase the amplifying magnification of the operation amplifying module to increase the output voltage value, n is an integer, and n≤m.

6. The voltage control circuit according to claim 5, wherein m equals to 2, and the voltage control circuit comprises a first comparing module, a first increasing module, a second comparing module and a second increasing module;
wherein, when the comparing result of a first comparator of the first comparing module represents that the output current value is greater than a first predetermined current value, a first transistor of the first increasing module is conducted so that the first increasing module is connected to the second input terminal of the operation amplifying module to increase the amplifying magnification of the operation amplifying module to increase the output voltage value;
when the comparing result of a second comparator of the second comparing module represents that the output current value is greater than a second predetermined current value, a second transistor of the second increasing module is conducted so that the second increasing module is connected to the second input terminal of the operation amplifying module to increase the amplifying magnification of the operation amplifying module to increase the output voltage value;
wherein, the first predetermined current value is smaller than the second predetermined current value.

7. The voltage control circuit according to claim 6, wherein the first comparing module comprises the first transistor, the first increasing module comprises the first transistor and a third resistor, the second comparing module comprises the second comparator, and the second increasing module comprises the second transistor and a fourth resistor; wherein,
a positive input terminal of the first comparator receives the output current value detected by the current detecting module, a negative input terminal of the first comparator receives the first predetermined current value, and an output terminal of the first comparator is connected to a gate electrode of the first transistor;
a positive input terminal of the second comparator receives the output current value detected by the current detecting module, a negative input terminal of the second comparator receives the second predetermined current value, and an output terminal of the second comparator is connected to a gate electrode of the second transistor;
a source electrode of the first transistor is connected to ground, a drain electrode of the first transistor is connected to a first terminal of the third resistor, and a second terminal of the third resistor is connected to the second input terminal of the operation amplifier;
a source electrode of the second transistor is connected to ground, a drain electrode of the second transistor is connected to a first terminal of the fourth resistor, and a second terminal of the fourth resistor is connected to the second input terminal of the operation amplifier.

8. A display device comprising a voltage control circuit, wherein the voltage control circuit comprises an operation amplifying module, a current detecting module, a comparing module and an increasing module, wherein,
the operation amplifying module is configured for amplifying an input voltage on a first input terminal of the operation amplifying module and outputting the amplified input voltage to an output terminal of the power management integrated circuit, wherein the operation amplifying module generates an output current in accordance with the input voltage;
the current detecting module is configured for detecting an output current value of the power management integrated circuit and feeding back the output current value to the comparing module;
the comparing module is configured for comparing the output current value with a predetermined current value and outputting a comparing result of the comparison; and
the increasing module is configured for connecting to a second input terminal of the operation amplifying module to increase an amplifying magnification of the operation amplifying module when the comparing result represents that the output current value is greater than the predetermined current value, so as to increase an output voltage value of the power managing integrated circuit.

9. The display device according to claim 8, wherein the operation amplifying module comprises an operation amplifier, a first resistor and a second resistor, wherein a first input terminal of the operation amplifier receives an input voltage, a second terminal of the operation amplifier is connected to a first terminal of the first resistor, a second terminal of the first resistor is connected to ground, a first terminal of the second resistor is connected to a second input terminal of the operation amplifier, and a second terminal of the second resistor is connected to the output terminal of the power management integrated circuit;
wherein, when the voltage control circuit works normally, the operation amplifier amplifies a voltage input to the first input terminal of the operation amplifier and outputs the amplified voltage to the output terminal of the power management integrated circuit.

10. The display device according to claim 8, wherein the comparing module comprises a comparator, a positive input terminal of the comparator receives the output current value detected by the current detecting module, a negative input terminal of the comparator receives the predetermined current value, and an output terminal of the comparator is connected to the increasing module.

11. The display device according to claim 10, wherein the increasing module comprises a transistor and an increasing module resistor, a gate electrode of the transistor is connected to the output terminal of the comparator, a source electrode of the transistor is connected to ground, a drain electrode of the transistor is connected to a first terminal of the increasing module resistor, and a second terminal of the increasing module resistor is connected to the second input terminal of the operation amplifying module;
wherein, when the comparing result of the comparing module represents that the output current value is greater than the predetermined current value of the comparing module, the transistor is conducted, and the third resistor is connected to ground through the transistor so that the increasing module is connected to the second input terminal of the operation amplifying module to increase the output voltage value.

12. The display device according to claim 8, wherein the voltage control circuit comprises m comparing modules and m increasing modules, the m comparing modules are corresponding to the m increasing modules one by one, and m is an integer;
wherein, when a comparing result of a nth comparing module in the m comparing modules represents that the output current value is greater than a nth predetermined current value of the nth comparing module, the nth comparing module in the m comparing modules is connected to the second input terminal of the operation amplifying module due to the comparing result to increase the amplifying magnification of the operation amplifying module to increase the output voltage value, n is an integer, and n≤m.

13. The display device according to claim 12, wherein m equals to 2, and the voltage control circuit comprises a first comparing module, a first increasing module, a second comparing module and a second increasing module;
wherein, when the comparing result of a first comparator of the first comparing module represents that the output current value is greater than a first predetermined current value, a first transistor of the first increasing module is conducted so that the first increasing module is connected to the second input terminal of the operation amplifying module to increase the amplifying magnification of the operation amplifying module to increase the output voltage value;
when the comparing result of a second comparator of the second comparing module represents that the output current value is greater than a second predetermined current value, a second transistor of the second increasing module is conducted so that the second increasing module is connected to the second input terminal of the operation amplifying module to increase the amplifying magnification of the operation amplifying module to increase the output voltage value;
wherein, the first predetermined current value is smaller than the second predetermined current value.

14. The display device according to claim 13, wherein the first comparing module comprises the first transistor, the first increasing module comprises the first transistor and a third resistor, the second comparing module comprises the second comparator, and the second increasing module comprises the second transistor and a fourth resistor; wherein,
a positive input terminal of the first comparator receives the output current value detected by the current detecting module, a negative input terminal of the first comparator receives the first predetermined current value, and an output terminal of the first comparator is connected to a gate electrode of the first transistor;
a positive input terminal of the second comparator receives the output current value detected by the current detecting module, a negative input terminal of the second comparator receives the second predetermined current value, and an output terminal of the second comparator is connected to a gate electrode of the second transistor;
a source electrode of the first transistor is connected to ground, a drain electrode of the first transistor is connected to a first terminal of the third resistor, and a second terminal of the third resistor is connected to the second input terminal of the operation amplifier;
a source electrode of the second transistor is connected to ground, a drain electrode of the second transistor is connected to a first terminal of the fourth resistor, and a second terminal of the fourth resistor is connected to the second input terminal of the operation amplifier.

15. A voltage control method applied to a voltage control circuit of a power management integrated circuit, comprising:
detecting an output current value output from the voltage control circuit;
comparing the output current value with a predetermined current value;
increasing an output voltage amplifying magnification of the voltage control circuit to increase an output voltage output from the voltage control circuit when the output current value is greater than the predetermined current value.

16. The voltage control method according to claim 15, wherein increasing the output voltage amplifying magnification of the voltage control circuit to increase the output voltage output from the voltage control circuit when the output current value is greater than the predetermined current value, comprising:
setting N predetermined current values, wherein N is an integer;
increasing the output voltage amplifying magnification to an amplifying magnification corresponding to an ith predetermined current value of the N predetermined current values when the output current value is greater than the ith predetermined current value.
